(19) United States
(12) Patent Application Publication
(10) Pub. No.: US 2026/0309991 A1
(43) Pub. Date: Oct. 8, 2026

(54) LOW REFLECTIVITY HIGH EFFICIENCY INPUT COUPLERS FOR GHOST MITIGATION

(71) Applicant: Applied Materials, Inc., Santa Clara, CA (US)

(72) Inventors: Simon LORENZO, Santa Clara, CA (US); David Alexander SELL, Santa Clara, CA (US); Evan WANG, Palo Alto, CA (US)

(21) Appl. No.: 19/630,908

(22) Filed: Mar. 27, 2026

Related U.S. Application Data
(60) Provisional application No. 63/783,275, filed on Apr. 4, 2025.

(51) Int. Cl. G02B 27/01

(52) U.S. Cl. CPC G02B 27/0172; G02B 2027/012

(57) ABSTRACT

Embodiments described herein relate to waveguides for augmented, virtual, and mixed reality. In one or more embodiments, an augmented reality waveguide is provided. The augmented reality waveguide includes a substrate and an input incoupler (IC) grating of slanted structures having a slant angle relative to a surface normal of the substrate. The slanted structures of the IC grating include a substrate section disposed in the substrate. The substrate section has a substrate refractive index. The slanted structures of the IC grating further include a first layer disposed on the substrate and a second layer disposed on the first layer. The first layer has a first refractive index greater than the substrate refractive index, and the second layer has a second refractive index less than the first refractive index.

### CROSS-REFERENCE TO RELATED APPLICATIONS

This application claims priority to United States Provisional Patent Application Serial No. 63/783,275, filed on Apr. 4, 2025, which herein is incorporated by reference.

### BACKGROUND

### Field

Embodiments of the present disclosure generally relate to waveguides for augmented, virtual, and mixed reality. More specifically, embodiments described herein provide for waveguides having incoupler (IC) gratings with a low reflectivity and high efficiency.

### Description of the Related Art

Virtual reality is generally considered to be a computer generated simulated environment in which a user has an apparent physical presence. A virtual reality experience can be generated in three dimensions (3D) and viewed with a head-mounted display (HMD), such as glasses or other wearable display devices that have near-eye display panels as lenses to display a virtual reality environment that replaces an actual environment.

Augmented reality, however, enables an experience in which a user can still see through the display lenses of the glasses or other HMD device to view the surrounding environment, yet also see images of virtual objects that are generated for display and appear as part of the environment. Augmented reality can include any type of input, such as audio and haptic inputs, as well as virtual images, graphics, and video that enhances or augments the environment that the user experiences. Many augmented reality display systems utilize optical waveguides to direct image from a light engine to the user’s eye.

In some waveguide based display systems, incoupler gratings may be used to couple light from the light engine into the waveguide. However, conventional incoupler gratings may exhibit high reflectivity, which can reduce system efficiency and introduce undesired optical artifacts.

Accordingly, what is needed in the art are waveguides having incoupler gratings with a low reflectivity and high efficiency.

### SUMMARY

In one or more embodiments, an augmented reality waveguide is provided. The augmented reality waveguide includes a substrate and an input incoupler (IC) grating of slanted structures having a slant angle relative to a surface normal of the substrate. The slanted structures of the IC grating include a substrate section disposed in the substrate. The substrate section has a substrate refractive index. The slanted structures of the IC grating further include a first layer disposed on the substrate and a second layer disposed on the first layer. The first layer has a first refractive index greater than the substrate refractive index, and the second layer has a second refractive index less than the first refractive index.

In one or more embodiments, an augmented reality waveguide is provided. The augmented reality waveguide includes a substrate and an input incoupler (IC) grating of slanted structures having a slant angle relative to a surface normal of the substrate. The slanted structures of the IC grating include a substrate section disposed in the substrate. The substrate section has a substrate refractive index of at least 1.7. The slanted structures of the IC grating further include a first layer disposed on the substrate and a second layer disposed on the first layer. The first layer has a first refractive index greater than the substrate refractive index, and the second layer has a second refractive index less than the first refractive index. The augmented reality waveguide further includes a pupil expansion (PE) grating and an outcoupler (OC) grating. The PE grating and the OC grating at least include the first layer.

In one or more embodiments, an augmented reality waveguide is provided. The augmented reality waveguide includes a substrate and an input incoupler (IC) grating of slanted structures having a slant angle relative to a surface normal of the substrate. The slanted structures of the IC grating include a substrate section disposed in the substrate and a grating material layer disposed on the substrate. The substrate section has a substrate refractive index , and the grating material layer has a refractive index greater than the substrate refractive index.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments of the disclosure and are therefore not to be considered limiting of its scope, as the disclosure may admit to other equally effective embodiments.

FIG. 1 is a schematic, front view of a waveguide, according to embodiments described herein.

FIG. 2A is a schematic, cross sectional view of a waveguide, according to embodiments described herein.

FIG. 2B is a schematic illustration of a test image outcoupled from the waveguide of FIG. 2A, according to embodiments described herein.

FIG. 3A is a schematic, cross sectional view of a waveguide having a first configuration, according to embodiments described herein.

FIG. 3B is a schematic, cross sectional view of a waveguide having a second configuration, according to embodiments described herein.

FIG. 3C is a schematic, cross sectional view of a waveguide having a third configuration, according to embodiments described herein.

FIG. 3D is a schematic illustration of a test image outcoupled from the waveguides of FIGS. 3A-3C, according to embodiments described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present invention generally relate to waveguides for augmented, virtual, and mixed reality. More specifically, embodiments described herein provide for waveguides having incoupler (IC) gratings with a low reflectivity and high efficiency.

Augmented reality enables an experience in which a user can still see through the display lenses of glasses or another head-mounted display (HMD) device to view the surrounding environment, yet also see images of virtual objects that are generated for display and appear as part of the environment. Many augmented reality display systems utilize optical waveguides to direct image from a light engine to the user’s eye.

In some waveguide based display systems, incoupler (IC) gratings may be used to couple light from the light engine into the waveguide. Conventional incoupler gratings may include reflective or metallized structures to improve coupling efficiency. However, such structures may exhibit high reflectivity, which can cause a portion of the incident light to be reflected back into the optical system. These reflections can produce undesired optical artifacts, such as ghost images, and may reduce overall system performance.

Beneficially, embodiments described herein provide waveguides having IC gratings configured to reduce optical reflectivity while maintaining high efficiency. In particular, the IC gratings described herein do not require metal encapsulation, which can make conventional waveguides susceptible to ghost imaging. In some embodiments, the IC includes an unmetalized, asymmetric slanted grating structure configured to direct incident light into a desired diffraction order while minimizing reflections that can lead to ghost artifacts. As a result, improved optical efficiency and image quality may be achieved in augmented reality display systems.

As used herein the term “high efficiency” may refer to an IC grating exhibiting a diffraction efficiency to the +1 diffraction order, averaged over the device field-of-view, of greater than about 50% for each of the red, green, and blue color channels. In some embodiments, the IC gratings described herein achieve such efficiency while maintaining reduced optical reflectivity relative to conventional metallized incoupler structures.

As used herein, the term “low reflectivity” may refer to an IC grating exhibiting a reflectivity of less than about 5%. In some embodiments, the reflectivity may be less than about 5% when photopically weighed across the visible spectrum. In other embodiments, the reflectivity may be less than about 5% for each of the red, green, and blue color channels.

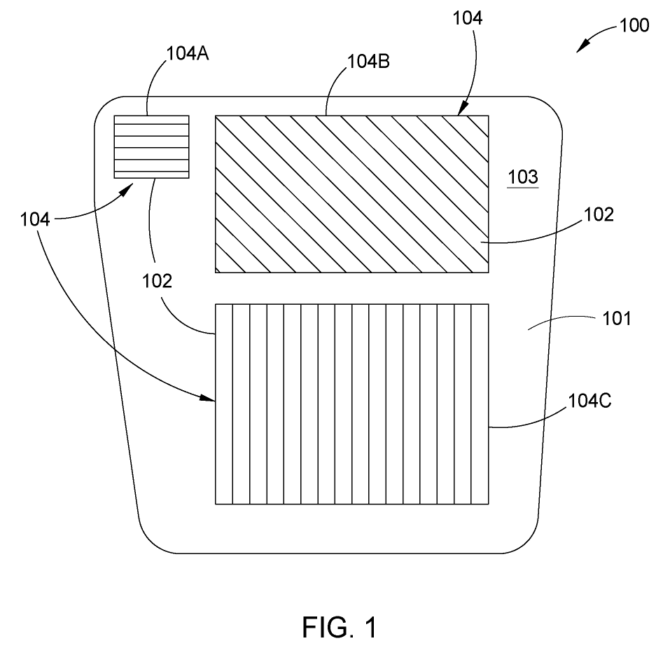

FIG. 1 is a schematic, front view of a waveguide 100. The waveguide 100 described herein is, for example, a waveguide for augmented reality. The waveguide 100 is also described as an augmented reality waveguide. The waveguide 100 includes a plurality of structures 102 disposed in, on, or over a surface 103 in the substrate 101.

The substrate 101 can be any substrate used in the art, and can be either opaque or transparent to a chosen wavelength of light, depending on the intended use. Substrate selection may include substrates of any suitable material, including, but not limited to, amorphous dielectrics, non-amorphous dielectrics, crystalline dielectrics, polymers, or combinations thereof. In some embodiments, the substrate 101 includes, but is not limited to, a silicon-containing material, a silicon and oxygen containing compound, a germanium-containing material, a indium and phosphide containing compound, a gallium and arsenic containing compound, a gallium and nitrogen containing compound, a carbon-containing material, a silicon and carbon containing compound, a silicon, carbon, and oxygen containing compound, a silicon and nitrogen containing compound, a silicon, oxygen, and nitrogen containing compound, a niobium and oxygen containing compound, and lithium, niobium, and oxygen containing compound, an aluminum and oxygen containing compound, a indium, tin, and oxygen containing compound, a titanium and oxygen containing compound, a lanthanum and oxygen containing compound, a gadolinium and oxygen containing compound, a zinc and oxygen containing compound, a yttrium and oxygen containing compound, a tungsten and oxygen containing compound, a potassium, and oxygen containing compound, a phosphorous and oxygen containing compound, a barium and oxygen containing compound, a sodium and oxygen containing compound, or combinations thereof. In other embodiments, which can be combined with other embodiments described herein, the substrate 101 includes an oxide including one or more of gadolinium, silicon, sodium, barium, potassium, tungsten, phosphorus, zinc, calcium, titanium, tantalum, niobium, lanthanum, zirconium, lithium, or yttrium containing-materials. Example materials of the substrate 101 include silicon (Si), silicon monoxide (SiO), silicon dioxide (SiO₂), silicon carbide (SiC), fused silica, diamond, quartz germanium (Ge), silicon germanium (SiGe), indium phosphide (InP), gallium arsenide (GaAs), gallium nitride (GaN), sapphire, sapphire (Al₂O₃), lithium niobate (LiNbO₃), indium tin oxide (ITO), lanthanum oxide (La₂O₃), gadolinium oxide (Gd2O₅), zinc oxide (ZnO), yttrium oxide (Y₂O₃), tungsten oxide (WO₃), titatium oxide (TiO₂), zirconium oxide (ZrO₃), sodium oxide (Na₂O), niobium oxide (Nb₂O₅), barium oxide (BaO), potassium oxide (K2O), phosphorus pentoxide (P₂O₅), calcium oxide (CaO), or combinations thereof. The substrate 101, as described herein, has a substrate refractive index of at least 1.7.

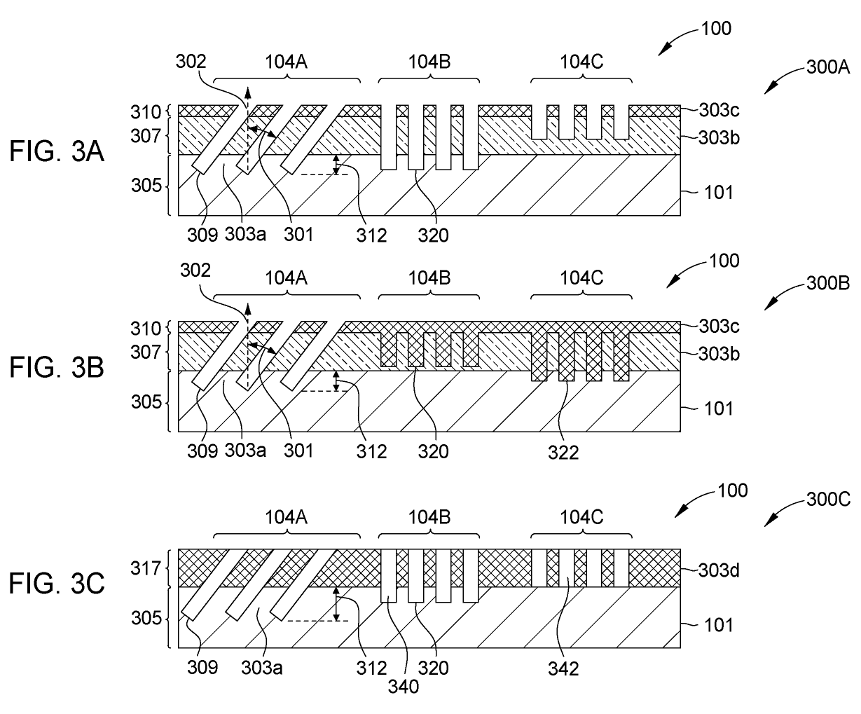

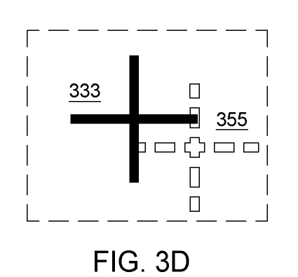

The plurality of structures 102 may be nanostructures having sub-micron dimensions, e.g., nano-sized dimensions. In some embodiments, which may be combined with other embodiments, the plurality of structures 102 disposed on the surface 103 of the substrate 101 and the substrate 101 itself include a different material. The plurality of structures 102 include, but are not limited to, materials (e.g., first layer 303b, second layer 303c, and grating material layer 303d shown in FIGS. 3A-3C) such as one or more oxides, carbides, or nitrides of silicon, aluminum, zirconium, tin, tantalum, zirconium, barium, titanium, hafnium, lithium, lanthanum, cadmium, niobium, or combinations thereof. Example materials of the plurality of structures 102 include silicon carbide, silicon oxycarbide, titanium oxide, silicon oxide, vanadium oxide, aluminum oxide, aluminum-doped zinc oxide, indium tin oxide, tin oxide, zinc oxide, tantalum oxide, silicon nitride, zirconium oxide, niobium oxide, cadmium stannate, silicon oxynitride, barium titanate, diamond like carbon, hafnium oxide, lithium niobate, silicon carbon-nitride, silver, cadmium selenide, mercury telluride, zinc selenide, silver-indium-gallium-sulfur, silver-indium-sulfur, indium phosphide, gallium phosphide, lead sulfide, lead selenide, zinc sulfide, molybdenum sulfide, tungsten sulfide, or combinations thereof. The plurality of structures 102 disposed on the surface 103 of the substrate 101 may have other cross-sections including, but not limited to, circular, triangular, elliptical, regular polygonal, irregular polygonal, and/or irregular shaped cross-sections.

Regions of the structures 102 correspond to one or more gratings 104. The waveguide 100 includes an incoupler grating (IC) 104A, a pupil expander grating (PE) 104B, and an outcoupler grating (OC) 104C corresponding to regions of the structures 102 as shown in FIG. 1.

In a first configuration 300A and a second configuration 300B, as shown in FIGS. 3A and 3B, respectively, the plurality of structures 102 of the IC 104A include a substrate section 303a of the substrate 101, a first layer 303b, and a second layer 303c. The structures 102 have a refractive index gradient corresponding to the substrate section 303a of the substrate 101. Stated otherwise, the refractive index of the structures 102 varies for each one of the layers (i.e., the refractive index of the substrate section 303aof the substrate 101 (substrate refractive index), the refractive index of the first layer 303b, and the refractive index of the second layer 303c). The first layer 303bhas a first refractive index greater than the substrate refractive index. The second layer 303chas a second refractive index that is less than the first refractive index and greater than the refractive index of air (i.e., greater than 1.0). The substrate refractive index is 1.7 or greater.

The IC 104A receives incident beams of light (e.g., a virtual image) having an intensity from a microdisplay. The virtual image of incident light includes red, green, and blue channels. The red, green, and blue channels correspond to red, green, and blue wavelengths of light. Each one of the plurality of structures 102 of the IC 104A splits the incident beams (red, green, blue channels) into a plurality of modes, each beam having a mode. Zero-order mode (T0) beams are refracted back or lost in the waveguide 100, positive first-order mode (T1) beams are coupled though the waveguide 100 to the OC 104C, and negative first-order mode (T-1) beams propagate in the waveguide 100 in a direction opposite to the T1 beams (i.e., +1 diffraction order direction beams). The T1 beams undergo total-internal-reflection (TIR) through the waveguide 100 until the T1 beams come in contact with the plurality of structures 102 in the PE 104B. A portion of the IC 104Amay have a first portion with a plurality of structures 102 with a slant angle different than the slant angle of the plurality of structures 102 from a second adjacent portion of the IC 104A. In order to reduce ghost imaging and maximize the efficiency (i.e., the diffraction efficiency) of the waveguide 100, it is desirable to limit the number of zero-order mode and negative first-order mode beams. Beneficially, the ICs 104Ahaving the first configuration 300A, the second configuration 300B, and the third configuration 300C have a low reflectivity and high efficiency to direct the light in the intended +1 diffraction order direction.

The T1 beams that undergo TIR in the PE 104B continue to contact the plurality of structures 102 until either the intensity of the T1 beams coupled through the waveguide 100 to the PE 104B is depleted, or remaining T1 beams propagating through the PE 104B reach the end of the PE 104B. The plurality of structures 102 must be tuned to control the T1 beams coupled through the waveguide 100 to the PE 104B in order to control the intensity of the T-1 beams coupled to the OC 104C to modulate a field of view of the virtual image produced from the microdisplay from a user’s perspective.

The T1 beams that undergo TIR in the OC 104C continue to contact the plurality of structures 102 until either the intensity of the T-1 beams coupled through the waveguide 100 to the OC 104C is depleted, or remaining T1 beams propagating through the OC 104C have reached the end of the OC 104C. The ICs 104A having the first configuration 300A, the second configuration 300B, and the third configuration 300C direct the light in the intended +1 diffraction order direction to reduce outcoupling of ghost (i.e., duplicated) images from zero-order mode and negative first-order mode beams.

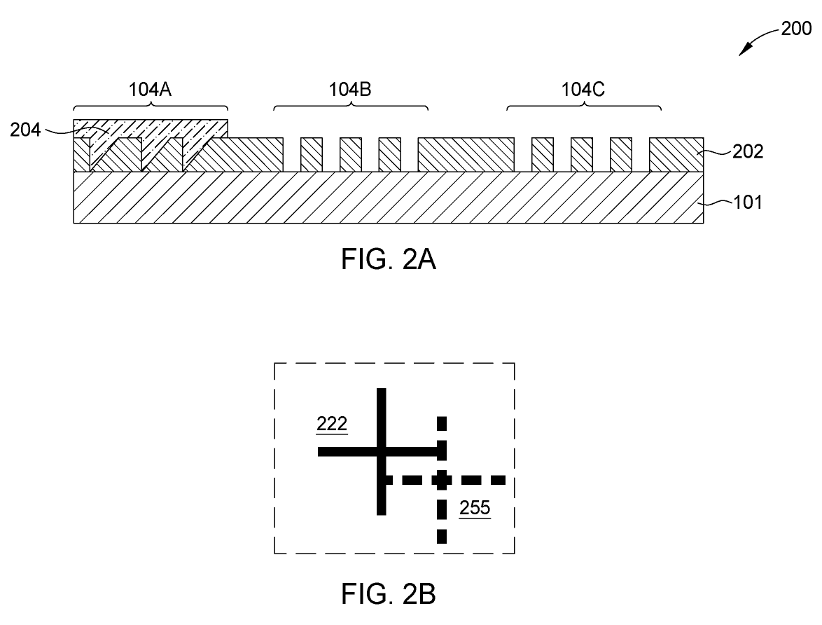

FIG. 2A is a schematic, cross sectional view of waveguide 200, according to embodiments described herein. The waveguide 200 is shown having a device material 202 disposed over the substrate. The IC 104A, the PE 104B, and the OC 104C are in the device material 202. In an effort to maintain a high efficiency to achieve acceptable device brightness and efficiency, high efficiency input coupler (HEICs) are metalized. Metal encapsulation 204 of the IC 204A, creates high reflection (e.g., greater than 20%) back to the light source which reflects back into the waveguide 200. FIG. 2B is a schematic illustration of a test image outcoupled from the waveguide 200. The metal encapsulation 204 of the IC 104A causes ghost (i.e., duplicated) images 255 at the OC 104C, as shown in FIG. 2B. As illustrated in FIG. 2B, both a real image 222 and a ghost image 255 are projected from the OC 104C to the user’s eye.

In order to reduce ghost imaging and maximize the efficiency (i.e., the diffraction efficiency) of the waveguide 100, it is desirable to limit the number of zero-order mode and negative first-order mode beams. Beneficially, the ICs 104A having the first configuration 300A, the second configuration 300B, and the third configuration 300C have a low reflectivity and high efficiency to direct the light in the intended +1 diffraction order direction.

FIG. 3A is a schematic, cross sectional view of a waveguide 100 having a first configuration 300A. The first configuration 300A includes the IC 104A, the PE 104B, and the OC 104C. The IC 104Aincludes a substrate section 303aof the substrate 101, a first layer 303b, and a second layer 303c. The PE 104B may include the substrate section 303aof the substrate 101, the first layer 303b, and the second layer 303c. In other embodiments, the PE 104B may include the substrate section 303aof the substrate 101 or the first layer 303b. The OC 104Cincludes the substrate section 303a of the substrate 101, the first layer 303b, and the second layer 303c. In other embodiments, the OC 104C may include the substrate section 303aof the substrate 101 or the first layer 303b. The PE 104B and the OC 104C may have the same first layer sections or different first layer sections. The PE 104B and the OC 104C may have the same first layer and second layer or may have different first and second layers.

The structures 102 of the waveguide 100 include gaps 309 therebetween. The IC 104A is an asymmetric slanted grating. An asymmetric slanted grating is a grating that includes structures 102 with a slant angle 301 (or slanted structures 102) relative to a surface normal 302 of the substrate 101. The slant angle 301 is at least 50 degrees. In some embodiments, the slant angle 301 is at least 65 degrees. The structures 102 have a refractive index gradient corresponding to the substrate section 303a of the substrate 101, the first refractive index of the first layer 303b, and the second refractive index of the second layer 303c. Stated otherwise, the refractive index of the structures 102 varies for each one of the layers (i.e., the refractive index of the substrate section 303aof the substrate 101 (substrate refractive index), the refractive index of the first layer 303b (first refractive index), and the refractive index of the second layer 303c (second refractive index). The first layer 303bhas a first refractive index greater than the substrate refractive index. The second layer 303c has a second refractive index that is less than the first refractive index and greater than the refractive index of air (i.e., greater than 1.0). The substrate refractive index is 1.7 or greater.

The slant angle 301 and the asymmetric structures 102 maintain a high diffraction efficiency of the IC 104A. The diffraction efficiency of the IC 104A is the percentage of incident light (red, green, blue channels from the source) that are diffracted in the +1 diffraction order averaged over the field-of view. The IC 104Ahaving the first configuration 300A has a diffraction efficiency of 50% or greater. The slant angle 301 of at least 50 degrees of the structures 102 of the asymmetric IC 104A achieve high efficiency and direct the light in the intended +1 diffraction order direction.

The substrate 101 has a substrate thickness 305 of about 300 micrometers (µm) to about 1000 µm. The total depth of structures 102 of the IC 104A are greater than 100 nanometers (nm). The substrate section 303ahas a substrate section thickness 312. The substrate section thickness 312 has a range from about 0 nm to about 250 nm, such as about 25 nm to about 115 nm. The first layer 303b has a first thickness 307 of about 25 nanometers (nm) to about 150 nm. The second layer 303chas a second thickness 310 of about 25 nm to about 150 nm. The refractive index gradient corresponding to the substrate section 303a, the first layer 303b, and the second layer 303c provides for low reflectivity of the IC 104A of the first configuration 300A. The reflectivity is the percentage of incident light that is reflected instead of being coupled into the waveguide 100 through the IC 104A. Reflectivity is defined as the percentage of incident light including the red, green, and blue channels that is reflected back to the source. The IC 104A having the first configuration 300A has a reflectivity of 5% or less. The thickness of the second layer 303c and the total depth (i.e., the substrate section thickness 312, the first thickness 307, and the second thickness 310) further control the reflectivity refractive index gradient and are chosen to minimize reflection.

In one embodiment, the first layer 303b includes, but is not limited to, titanium oxide, niobium oxide , or combinations thereof. In this embodiment, the second layer 303cincludes, but is not limited to, silicon oxide, aluminum oxide, silicon oxynitride, or combinations thereof. In this embodiment, the substrate 101 includes, but is not limited to, lithium niobate, silicon carbide, or combinations thereof. The structures 102 have a pitch of about 100 nm to about 400 nm. The structures 102 have a duty cycle of about 0.1 to about 0.9.

FIG. 3B is a schematic, cross sectional view of a waveguide 100 having a second configuration 300B. The second configuration 300B includes the IC 104A, the PE 104B, and the OC 104C. The IC 104A includes the substrate section 303aof the substrate 101, a first layer 303b, and a second layer 303c. The PE 104Bmay include the substrate section 303a of the substrate 101, the first layer 303b, and the second layer 303c. In one embodiment, the structures 102 of the PE 104Binclude gaps 320 therebetween. The second layer 303c fills the gaps 320 of the structures 102 of the PE 104B. The OC 104C may include the substrate section 303aof the substrate 101, the first layer 303b, and the second layer 303c. In one embodiment, the structures 102 of the OC 104C include gaps 322 therebetween. The second layer 303cfills the gaps 322 of the structures 102 of the OC 104C. The PE 104B and the OC 104C may have the same first layer sections or different first layer sections. The PE 104B and the OC 104C may have the same first layer and second layer or may have different first and second layers.

The structures 102 of the waveguide 100 include gaps 309 therebetween. The IC 104A is an asymmetric slanted grating. An asymmetric slanted grating is a grating that includes structures 102 with a slant angle 301 (or slanted structures 102) relative to a surface normal 302 of the substrate 101. The slant angle 301 is at least 50 degrees. In some embodiments, the slant angle 301 is at least 65 degrees. The structures 102 have a refractive index gradient corresponding to the substrate section 303a of the substrate 101, the first refractive index of the first layer 303b, and the second refractive index of the second layer 303c. Stated otherwise, the refractive index of the structures 102 varies for each one of the layers (i.e., the refractive index of the substrate section 303aof the substrate 101 (substrate refractive index), the refractive index of the first layer 303b, and the refractive index of the second layer 303c). The first layer 303bhas a first refractive index greater than the substrate refractive index. The second layer 303c has a second refractive index that is less than the first refractive index and greater than the refractive index of air (i.e., greater than 1.0). The substrate refractive index is 1.7 or greater.

The slant angle 301 and the asymmetric structures 102 maintain a high diffraction efficiency of the IC 104A. The diffraction efficiency of the IC 104Ais the percentage of incident light (red, green, blue channels from the source) that are diffracted in the +1 diffraction order averaged over the field-of view. The IC 104Ahaving the second configuration 300Bhas a diffraction efficiency of 50% or greater. The slant angle 301 of at least 50 degrees of the structures 102 of the asymmetric IC 104A achieve high efficiency and direct the light in the intended +1 diffraction order direction.

The substrate 101 has a substrate thickness 305 of about 300 micrometers (µm) to about 1000 µm. The total depth of structures 102 of the IC 104A are greater than 100 nanometers (nm). The substrate section 303ahas a substrate section thickness 312. The substrate section thickness 312 has a range from about 0 nm to about 250 nm, such as about 25 nm to about 115 nm. The first layer 303bhas a first thickness 307 of about 25 nanometers (nm) to about 150 nm. The second layer 303c has a second thickness 310 form about 25 nm to about 150 nm. The refractive index gradient corresponding to the substrate section 303a, the first layer 303b, and the second layer 303c provides for low reflectivity of the IC 104A of the second configuration 300B. The reflectivity is the percentage of incident light that is reflected instead of being coupled into the waveguide 100 through the IC 104A. Reflectivity is defined as the percentage of incident light including the red, green, and blue channels that is reflected back to the source. The IC 104Ahaving the second configuration 300B has a reflectivity of 5% or less. The thickness of the second layer 303c and the total depth further control the reflectivity and refractive index gradient and are selected to minimize optical reflection.

In one embodiment, the first layer 303b includes, but is not limited to, titanium oxide, niobium oxide, or combinations thereof. In this embodiment, the second layer 303cincludes, but is not limited to, silicon oxide, aluminum oxide, silicon oxynitride, or combinations thereof. In this embodiment, the substrate 101 includes, but is not limited to, lithium niobate, silicon carbide, or combinations thereof. The structures 102 have a pitch of about 100 nm to about 400 nm. The structures 102 have a duty cycle of about 0.1 to about 0.9.

FIG. 3C is a schematic, cross sectional view of a waveguide 100 having a third configuration 300C. The third configuration 300Cincludes the IC 104A, the PE 104B, and the OC 104C. The IC 104A includes the substrate section 303aof the substrate 101and a grating material layer 303d. The PE 104Bmay include the substrate section 303aof the substrate 101 and the grating material layer 303d, or only the grating material layer 303d. In this configuration, the structures 102 of the PE 104B include gaps 340 therebetween. The OC 104C includes the substrate section 303a of the substrate 101 and the grating material layer 303d or only the grating material layer 303d. In this configuration, the structures 102 of the PE include gaps 342 therebetween. The PE 104B and the OC 104C may have the same first layer sections or different first layer sections. The PE 104B and the OC 104C may have the same first layer and second layer or may have different first and second layers.

Similarly as described above for configurations 300A and 300B, the slanted structures 102 of the IC 104A of the waveguide 100 include gaps 309 therebetween. The IC 104Ais an asymmetric slanted grating. An asymmetric slanted grating is a grating that includes structures 102 with a slant angle 301 relative to a surface normal 302 of the substrate 101. The slant angle 301 is at least 50 degrees. In some embodiments, the slant angle 301 is at least 65 degrees. The structures 102, of the IC 104Aof the third configuration 300C, have a refractive index gradient corresponding to the substrate refractive index of substrate section 303a and the refractive index of the grating material layer 303d. Stated otherwise, the refractive index of the structures 102 varies for each one of the layers (i.e., the refractive index of the substrate section 303aof the substrate 101 (substrate refractive index) and the refractive index of the grating material layer 303d. The refractive index of the grating material layer 303d is greater than the substrate refractive index. The refractive index of the grating material layer 303d is 2.0 or greater. The substrate refractive index is 1.7 or greater.

The slant angle 301 and the asymmetric structures 102 maintain a high diffraction efficiency of the IC 104A. The diffraction efficiency of the IC 104Ais the percentage of incident light (red, green, blue channels from the source) that are diffracted in the +1 diffraction order averaged over the field-of view. The IC 104Ahaving the third configuration 300Chas a diffraction efficiency of 50% or greater. The slant angle 301 of at least 50 degrees of the structures 102 of the asymmetric IC 104A achieve high efficiency and direct the light in the intended +1 diffraction order direction.

The total depth of structures 102 of the IC 104A of the third configuration 300C are greater than 100 nanometers (nm). The substrate section thickness 312 of the substrate section 303a has a range from about 0 nm to about 250 nm, such as about 25 nm, or such as about 115 nm. The grating material thickness 317 of the grating material layer 303d has a range from about 0 nm to about 300 nm, such as about 50 nm, or such as about 150 nm. The refractive index gradient corresponding to the substrate section 303a of the substrate 101 provides for low reflectivity of the IC 104A. Reflectivity is defined as the percentage of incident light including the red, green, and blue channels that is reflected back to the source. The IC 104Ahaving the third configuration 300Chas a reflectivity of 5% or less. The thickness of the grating material layer 303dand the total depth further control the reflectivity and refractive index gradient and are selected to minimize optical reflection.

The pitch of the structures 102 of the IC 104A of the third configuration 300C is about 100 nm to about 400 nm. The structures 102 have a duty cycle is about 0.1 to about 0.9.

FIG. 3D is a schematic illustration of a test image outcoupled from the waveguide 100 having one of the first configuration 300A, the second configuration 300B, or the third configuration 300C. As shown in in FIG. 3D, the test image 333 is prominently visible. In some embodiments, a ghost image 355 may still be present; however the ghost image 355 is substantially reduced in intensity and is dim or nearly non-visible compared to the ghost image 255 in FIG. 2B. In FIG. 3D, the ghost image 355 is illustrated with a faint contour for reference.

Beneficially, the ICs 104A provided herein have high diffraction efficiency and a low reflectivity. The high diffraction efficiency is provided by the slant angle 301 of structures 102 that are at least 50 degrees and by the asymmetric structures 102 of the ICs 104A. The low reflectivity is provided by the refractive index gradient of the structures 102 of the ICs 104A. The slant angle 301 and the unmetallized asymmetric structures 102 of the first configuration 300A, the second configuration 300B, and the third configuration 300C of the IC 104A achieve high efficiency and direct the light in the intended +1 diffraction order direction while minimizing reflections that can lead to ghost artifacts. As a result, improved optical efficiency and image quality may be achieved in augmented reality display systems .

While the foregoing is directed to examples of the present disclosure, other and further examples of the disclosure may be devised without departing from the basic scope thereof, and the scope thereof is determined by the claims that follow.

What is claimed is:

1. An augmented reality waveguide, comprising:
a substrate; and
an incoupler (IC) grating of slanted structures having a slant angle relative to a surface normal of the substrate, the slanted structures comprising:
a substrate section disposed in the substrate, the substrate section having a substrate refractive index;
a first layer disposed on the substrate, the first layer having a first refractive index greater than the substrate refractive index; and
a second layer disposed on the first layer, the second layer having a second refractive index less than the first refractive index.

2. The augmented reality waveguide of claim 1, wherein:
the first layer has a first thickness from about 25 nanometers (nm) to about 150 nm; and
the second layer has a second thickness from about 25 nm to about 150 nm.

3. The augmented reality waveguide of claim 2, wherein the substrate section has a section thickness of about 0 nm to about 250 nm.

4. The augmented reality waveguide of claim 1, wherein the substrate comprises lithium niobate, silicon carbide, or combinations thereof.

5. The augmented reality waveguide of claim 1, wherein the substrate refractive index is at least 1.7.

6. The augmented reality waveguide of claim 1, wherein the IC grating is unmetallized and configured to couple incident light into the substrate with a reflectivity of 5% or less.

7. The augmented reality waveguide of claim 1, further comprising a pupil expansion (PE) grating and an outcoupler (OC) grating, the PE grating and the OC grating at least include the first layer.

8. The augmented reality waveguide of claim 1, wherein the first layer comprises titanium oxide, niobium oxide, or combinations thereof.

9. The augmented reality waveguide of claim 1, wherein the second layer comprises silicon oxide, aluminum oxide, silicon oxynitride, or combinations thereof.

10. The augmented reality waveguide of claim 1, wherein the slant angle is at least 65 degrees.

11. An augmented reality waveguide, comprising:
a substrate; and
an incoupler (IC) grating of slanted structures having a slant angle relative to a surface normal of the substrate, the slanted structures comprising:
a substrate section disposed in the substrate, the substrate section having a substrate refractive index of at least 1.7;
a first layer disposed on the substrate, the first layer having a first refractive index greater than the substrate refractive index; and
a second layer disposed on the first layer, the second layer having a second refractive index less than the first refractive index; and
a pupil expansion (PE) grating and an outcoupler (OC) grating, the PE grating and the OC grating at least including the first layer.

12. The augmented reality waveguide of claim 11, wherein the IC grating is unmetallized and configured to couple incident light into the substrate with a reflectivity of 5% or less.

13. The augmented reality waveguide of claim 11, wherein each of the slanted structures of the IC grating comprises a refractive index gradient in which the refractive index gradient varies across the substrate section, the first layer, and the second layer, and the refractive index gradient is configured to reduce optical reflectivity of the IC grating while maintaining a diffraction efficiency of at least 50% into a +1 diffraction order.

14. The augmented reality waveguide of claim 11, wherein the first layer comprises titanium oxide, niobium oxide, or combinations thereof.

15. The augmented reality waveguide of claim 11, wherein the second layer comprises silicon oxide, aluminum oxide, silicon oxynitride, or combinations thereof.

16. An augmented reality waveguide, comprising:
a substrate; and
an incoupler (IC) grating of slanted structures having a slant angle relative to a surface normal of the substrate, the slanted structures comprising:
a substrate section disposed in the substrate, the substrate section having a substrate refractive index; and
a grating material layer disposed on the substrate, the grating material layer having a refractive index greater than the substrate refractive index.

17. The augmented reality waveguide of claim 16, wherein the substrate comprises lithium niobate, silicon carbide, or combinations thereof.

18. The augmented reality waveguide of claim 16, wherein the IC grating is unmetallized and configured to couple incident light into the substrate with a reflectivity of 5% or less.

19. The augmented reality waveguide of claim 16, wherein the grating material layer comprises one or more oxides, carbides, or nitrides of silicon, aluminum, zirconium, tin, tantalum, barium, titanium, hafnium, lithium, lanthanum, cadmium, niobium, or combinations thereof.

20. The augmented reality waveguide of claim 16, wherein the slant angle is at least 65 degrees.
